(19) United States
(12) Patent Application Publication
(10) Pub. No.: US 2005/0246170 A1
(43) Pub. Date: Nov. 3, 2005

(54) Audio signal processing apparatus and method

(75) Inventors: Fabio Vignoli, Eindhoven (NL); Tatiana Lashina, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 10/517,913

(22) PCT Filed: May 27, 2003
(86) PCT No.: PCT/IB03/02299

§ 371 Date: Dec. 14, 2004

(30) Foreign Application Priority Data
Jun. 19, 2002 (EP) 02077421.2

(51) Int. Cl. G10L 21/02

(52) U.S. Cl. 704/226

(57) ABSTRACT

An audio signal processing apparatus (1) comprises an audio input (3) for an entered audio signal, an audio output (5) for outputting an outgoing audio signal, and a processor (9) for performing a transformation (2) to improve the intelligibility of speech present in the entered audio signal. The transformation (2) transforms the entered audio signal into the outgoing audio signal, by modeling at least one aspect of the Lombard effect, based upon a noise level value (7). The Lombard effect is a specific way in which people change their speech, when speaking in noisy environments. The audio signal processing apparatus can be applied in a television receiver and a radio program receiver.

The invention relates to an audio signal processing apparatus comprising an audio input for obtaining an entered audio signal, an audio output for outputting an outgoing audio signal, and a processor for performing a transformation to improve the intelligibility of speech present in the entered audio signal.

The invention also relates to a television receiver comprising such an audio signal processing apparatus.

The invention also relates to a radio program receiver comprising such an audio signal processing apparatus.

The invention also relates to method of increasing the intelligibility of an audio signal, the method comprising
a first step of obtaining an entered audio signal;
a second step of transforming the entered audio signal into an outgoing audio signal;
a third step of outputting the outgoing audio signal.

An apparatus for improving the intelligibility of speech in a television receiver is known from U.S. Pat. No. 6, 226,605. This patent describes the application of speech intelligibility algorithms known from a hearing aid in a television receiver. One of the algorithms in the known apparatus reproduces the speech at a lower speed by increasing the duration of silent periods between spoken words. It is a drawback of the known apparatus that the algorithms are designed to improve the intelligibility of speech for a particular person, but the algorithms do not take into account any specific non person related factors that influence the intelligibility of speech in an audio signal.

It is a first object of the invention to provide an apparatus of the kind described in the opening paragraph, which can improve the intelligibility of speech in a better way.

It is a second object of the invention to provide a television receiver of the kind described in the opening paragraph, which has means for enhancing the intelligibility of speech present in the incoming television signal in a better way than is known.

It is a third object of the invention to provide a radio program receiver of the kind described in the opening paragraph, which has means for enhancing the intelligibility of speech present in the incoming radio signal in a better way than is known.

It is a fourth object of the invention to provide a method of transforming an audio signal of the kind described in the opening paragraph, to enhance the intelligibility of speech present in the audio signal in a better way than is known.

The first object is realized in that the processor has a noise level value and has the ability to transform the entered audio signal into the outgoing audio signal by the transformation modeling at least one aspect of the Lombard effect, based upon the noise level value. The Lombard effect, or Lombard reflex, is a term indicating the changes of human speech when a speaker speaks in an environment with noise. Human speech is not always the same. A first class of speech changes comprises intended changes within a certain mode of speech. For example, a speaker can emphasize a word. A second class of speech changes comprises intended or unintended changes to a different speech mode. For example speech characteristics change when a speaker is tired, when he speaks in a vibrating environment or in a noisy environment. Some of the characteristics of the audio signal that change from normal to Lombard speech are e.g. signal volume, word length and pitch. Speech improvement can be applied to any audio signal, but is only useful when the audio signal contains some speech. The transformation according to the invention can provide a faithful speech intelligibility improvement which accurately models the changes from normal speech to Lombard speech, in which case one needs an accurate characterization of noise inducing the Lombard speech mode. This faithful transformation can either reproduce Lombard speech as a human utters it, or even improve the intelligibility of speech more than a human. Alternatively the transformation can approximate the Lombard effect, in which case it improves the speech intelligibility suboptimally, based on a less accurate noise level value.

A rather trivial transformation, solely increasing the audio signal volume depending on ambient noise exists in the prior art. U.S. Pat. No. 5,907,622 discloses an audio signal processing system which changes the audio signal volume based upon an ambient noise measurement, but performs no more advanced operations which further improve the intelligibility of speech in the audio signal in a higher quality way. The audio signal processing apparatus according to the invention implements at least one aspect of the Lombard effect in a more complex way than a simple signal volume adjustment, which is known in audio processing. Most of the aspects of the Lombard effect belong to the field of speech processing rather than to the field of audio signal processing. The audio signal processing apparatus according to the invention may also perform an additional signal volume adjustment, but this is not the gist of the invention.

In an embodiment of the audio signal processing apparatus of the invention, a microphone and a noise value extractor are present for providing the noise level value to the processor, from noise in the environment where the outgoing audio signal is reproduced. With this embodiment, the apparatus can improve the intelligibility of the entered audio signal when noise is present in the environment of the audio signal processing apparatus. The entered audio signal may already have been improved e.g. in a broadcasting studio, taking into account noise present during recording. A broadcaster has no way of knowing what noises occur during reproduction of the outgoing audio signal, and hence improvement has to be effected in the audio signal processing apparatus. To measure the noise of the environment of the audio signal processing apparatus, a microphone picks up sounds in this environment. The noise value extractor connected to the microphone generates a noise level value from an entered electrical audio signal coming from the microphone and entering the noise value extractor. Because, in general, the audio signal processing apparatus is connected to a loudspeaker for reproducing the outgoing audio signal, the microphone picks up the sound generated from the outgoing audio signal as well as other noise sounds present in the environment of the audio signal processing apparatus. Preferably, the transformation improves the intelligibility of speech depending on the noise level value derived from the other noise sounds solely, and not from the sound generated from the outgoing audio signal. To realize this, an adaptive echo cancellation algorithm may be present in the noise value extractor to diminish the contribution of the sound generated from the outgoing audio signal so that the noise level value is predominantly dependent on the other noise sounds in the environment.

It is advantageous if a noise value characterizer is present for retrieving the noise level value from the entered audio signal. In some broadcasts, e.g. a report on site, e.g. in a street, there is background noise present in the entered audio signal. A speaker may already apply the Lombard effect to compensate for this background noise, but the nuisance of the noise as perceived by the speaker is not necessarily equal to the nuisance in an audio signal picked up by a microphone. Furthermore, there is more noise added to the signal during broadcasting and transmission, e.g. due to compression or other audio signal transformations. It is therefore desirable that a noise measurement can be done of the noise present in the entered audio signal at the receiver side, to improve the intelligibility of the speech present in the entered audio signal. Embodiments similar to embodiments of the audio signal processing apparatus used at the receiver side can be used at the broadcaster side, so as to improve the intelligibility of speech in the same way for all receivers.

It is advantageous if a selection input is present for setting the noise level value to a chosen value. This enables a user to tune the intelligibility of the speech to his own liking. If the transformation does not model the Lombard effect perfectly, or if the noise is not characterized perfectly, or if the user just wants a partial, suboptimal speech intelligibility improvement, the user can set the noise level value to such a value that the speech intelligibility is improved in the way he likes it.

It is also advantageous if a signal type characterizing means is present, for supplying a signal type characterization value to the processor, and for enabling the processor to perform a transformation of the entered audio signal depending on the signal type characterization value. For example, the transformation is applied only when the signal type characterization value indicates that speech is present in the entered audio signal. Or the transformation is not applied when the signal type characterization value indicates e.g. that classical music is present, irrespective of whether speech is present simultaneously with the classical music. The signal type characterization value can be retrieved from additional data present in a received signal, e.g. the program type information in the Radio Data System (RDS). Furthermore, the entered audio signal can be analyzed to determine whether it contains e.g. speech or music, which is indicated by the signal type characterization value.

One of the aspects of the Lombard effect is that the spectral contour of the entered audio signal is changed on the basis of the noise level value. For example, the energy in a formant, or steepness of a formant, can be changed. Also the width of a formant, or the frequency of a formant can be changed. Alternatively, a non-linear transformation can be applied to the frequency axis of the spectrum yielding a new spectrum.

Another aspect of the Lombard effect is that the word length is changed on the basis of the noise level value. For example, a transformation which keeps the length of a piece of the entered audio signal fixed can shorten the silent periods between words to increase the duration of voiced pieces, which corresponds to the slower reproduction of words.

Furthermore, the pitch or volume of the entered audio signal can be changed on the basis of the noise level value.

More aspects of the Lombard effect are described in literature, e.g. in “J. C. Junqua: The Lombard reflex and its role on human listeners and automatic speech recognizers. Journal of the Acoustic Society of America, vol. 93, no. 1, January 1993, pp. 510-524.”

Instead of using a single noise level value characterizing the loudness of the noise, other values can characterize the noise more completely, e.g. the other values can characterize the frequency distribution of the noise.

The second object of the invention is realized in that a television receiver is equipped with one of the embodiments of the audio signal processing apparatus described above, to improve the intelligibility of speech present in an audio signal, which is extracted from the television signal by the television receiver. The intelligibility of speech in a television program is often not good enough to enable people with less acute hearing, e.g. the elderly, to follow the television program in a satisfactory way.

The third object of the invention is realized in that a radio program receiver is equipped with one of the embodiments of the audio signal processing apparatus described above, to improve the intelligibility of speech present in an audio signal, which is extracted from the radio program by the radio program receiver. For example, when a telephone conversation is broadcast during the radio program, the person on the other end of the telephone line is often hardly understandable.

The fourth object of the invention is realized in that the method obtains a noise level value, indicating the extent of noise influencing the intelligibility of a reproduction of the outgoing audio signal, and transforms the entered audio signal into the outgoing audio signal by a transformation modeling at least one aspect of the Lombard effect not being audio signal volume control, based upon the noise level value.

These and other aspects of the audio signal processing apparatus, the television receiver, the radio program receiver and the method of the invention will be apparent from and elucidated with reference to the implementations and embodiments described hereinafter, and with reference to the accompanying drawings, which serve merely as a non limiting illustration of some of the aspects or embodiments of the audio signal processing apparatus, the television receiver, the radio program receiver and the method according to the invention.

In the drawings:

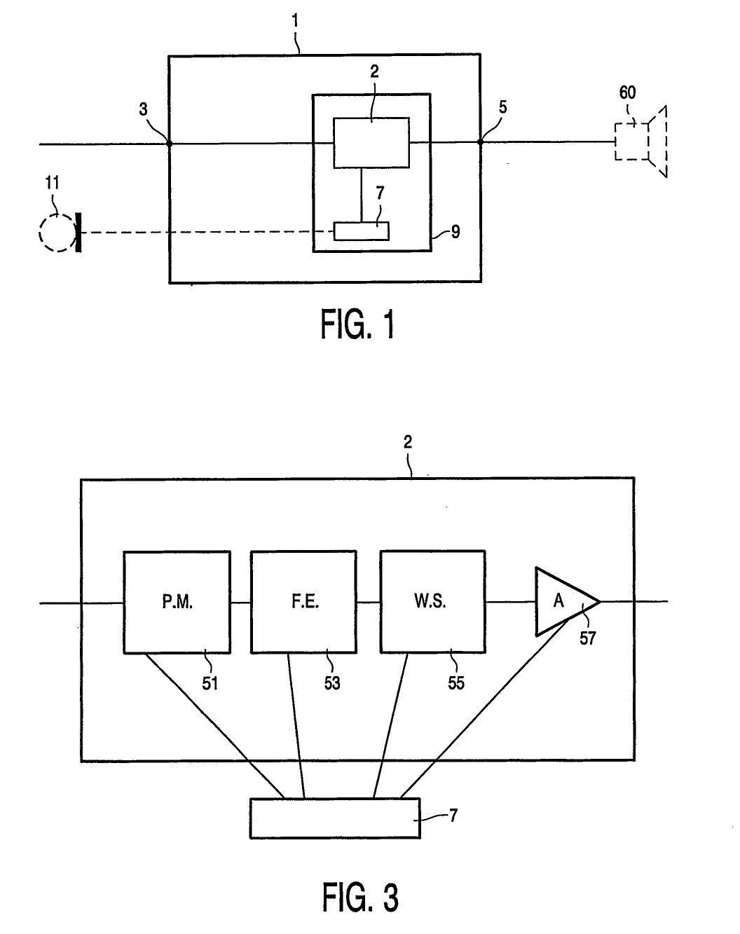

FIG. 1 is a generic form of the audio signal processing apparatus,

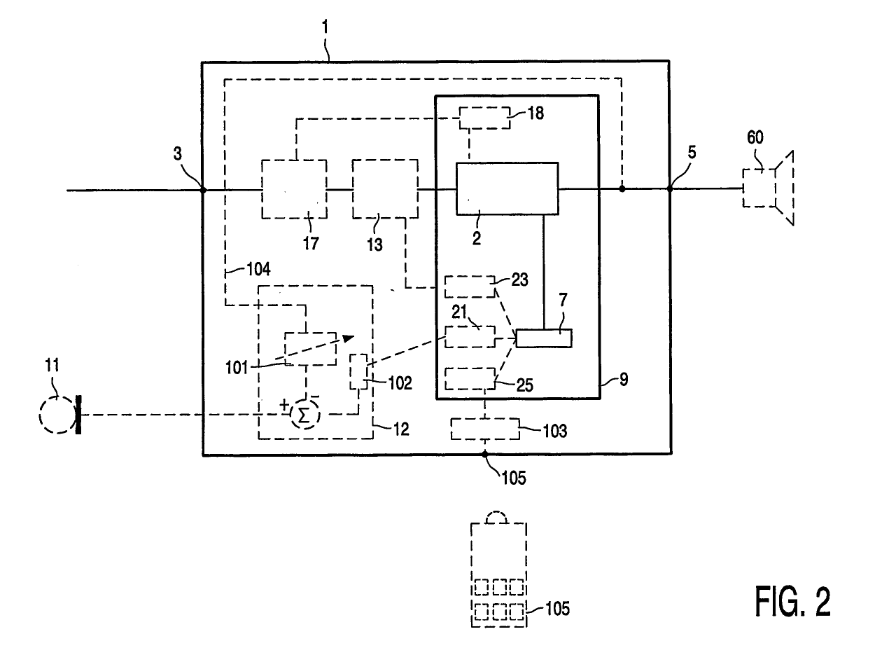

FIG. 2 is a specific embodiment comprising more features,

FIG. 3 is an example of a Lombard effect transformation,

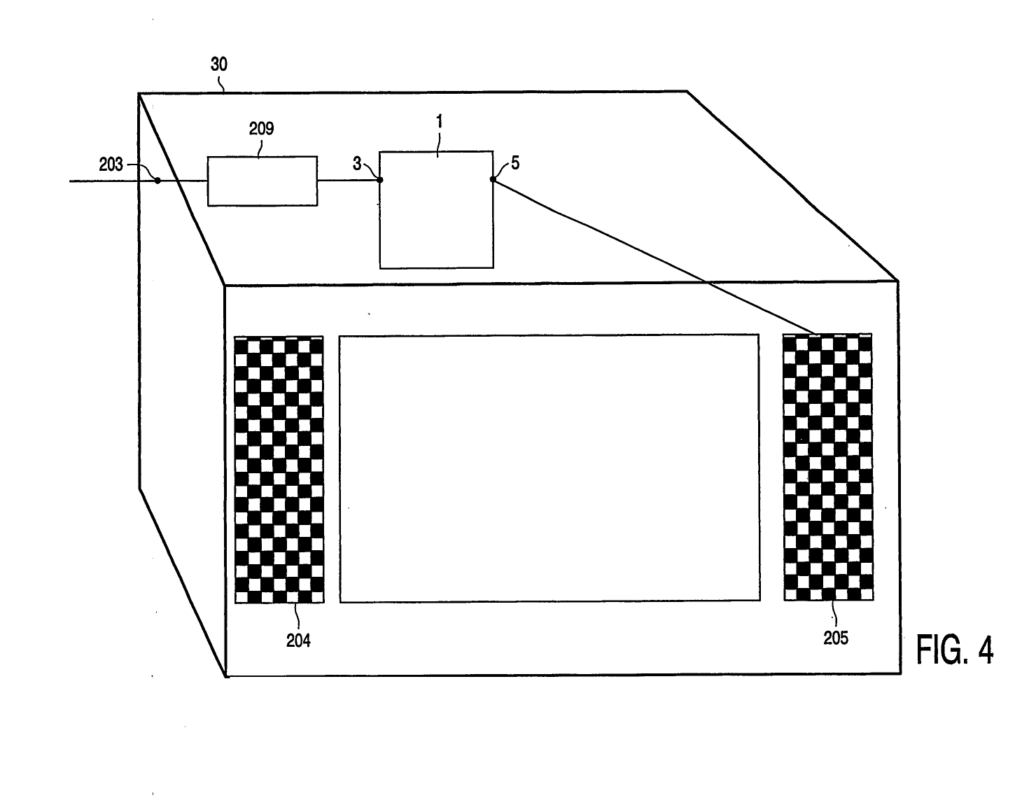

FIG. 4 is a television receiver comprising the audio signal processing apparatus,

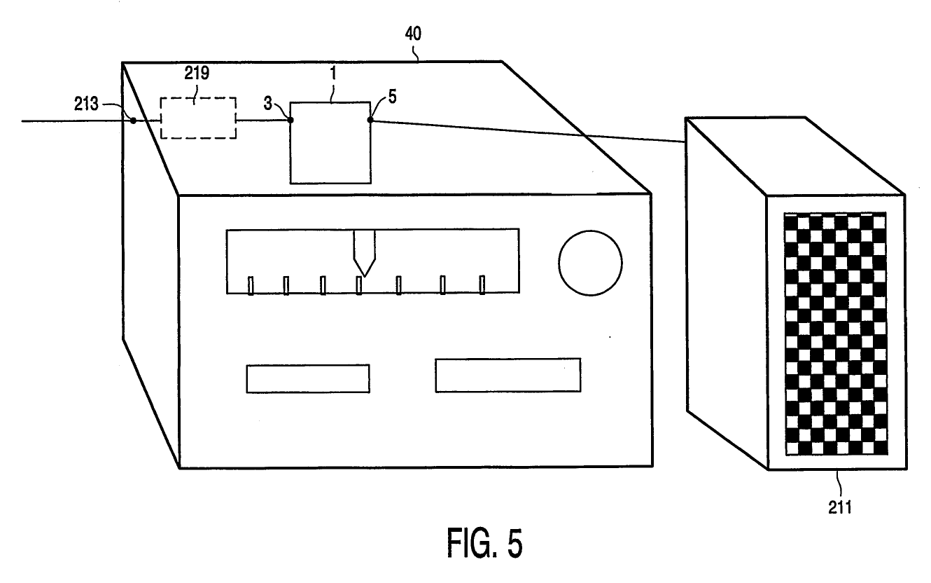

FIG. 5 is a radio program receiver comprising the audio signal processing apparatus, and

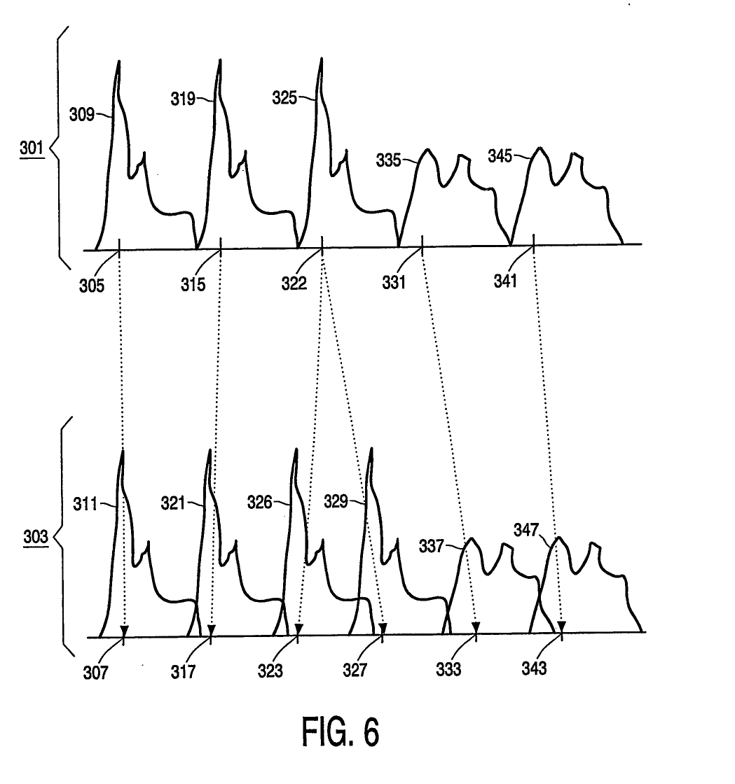

FIG. 6 shows schematically a Synchronized Overlap and Add synthesis.

In these Figures, elements with the same reference numeral in different Figures serve the same function, and elements drawn dashed are optional depending on the desired embodiment.

The audio signal processing apparatus 1 of FIG. 1 comprises an audio input 3 for obtaining an entered audio signal and an audio output 5 for outputting an outgoing audio signal. A processor 9 performs a transformation 2 to improve the intelligibility of speech present in the entered audio signal, modeling at least one aspect of the Lombard effect. The transformation 2 changes at least one characteristic of the entered audio signal on the basis of a noise level value 7 which is available to the processor. In specific embodiments, this noise level value 7 can be measured e.g. from the environment of the audio signal processing apparatus, in which case the processor 9 tries to improve the decreased intelligibility of a reproduction of the outgoing audio signal, due to environmental noise entering the ear of a listener. The outgoing audio signal may be reproduced by a loudspeaker 60.

FIG. 2 shows a more advanced embodiment of the audio signal processing apparatus 1, comprising more features. In a first noise level value 7 generation possibility, noise in the environment is picked up by means of a microphone 11. Apart from truly external noises in the environment, the microphone also picks up an audio signal component generated by the reproduction of the outgoing audio signal by the loudspeaker 60, connected to the audio signal processing apparatus 1. The audio signal component generated by the reproduction of the outgoing audio signal by the loudspeaker 60 in a preferred embodiment is first subtracted from the signal coming from the microphone 11, or else the noise value summarizer 102 supplies an incorrect noise level value 7, summarizing the extent of the noise in the environment, to the processor 9. An approximation of the audio signal component generated by the reproduction of the outgoing audio signal by the loudspeaker 60 and traveling through a room is subtracted from the signal coming from the microphone by means of an adaptive echo cancellation filter 101. The coefficients of this adaptive echo cancellation filter 101 model the transmission of the reproduction of the outgoing audio signal through the room, from the loudspeaker 60 to the microphone 11. The filter has as an input an outgoing signal feedback 104 from the outgoing audio signal. If the adaptive echo cancellation filter 101 is a digital linear filter, an optimal approximation of the audio signal component generated by the reproduction of the outgoing audio signal by the loudspeaker 60 is obtained by minimizing the error e(k) in:
e(k)=M(k)−\hat{ }r(k)=r(k)−\hat{ }r(k)+n(k) [1]

In this formula, k is a sampling time instant, M(k) the sampled value of the signal coming from the microphone at sampling time instant k, \hat{ }r(k) is an estimate by the adaptive filter of a sample r(k) of the audio signal component generated by the reproduction of the outgoing audio signal by the loudspeaker 60, and n(k) is a sample of the truly environmental noise as picked up by the microphone, which is desired by the noise value summarizer 102 for generating the appropriate noise level value 7. The linear adaptive echo cancellation filter 101 generates its output signal \hat{ }r(k) from its input o(k), which is the sampled outgoing audio signal, e.g. by means of the following formula:

$$\hat{} r ( k ) = {\sum }_{p = 0}^{M} {w}_{p} ( k ) o ( k - p ) \qquad [ 2 ]$$

The estimation of the filter coefficients wₚ(k) by minimizing the error e(k) can be done in a number of ways, e.g. by a least squares technique. More information can be obtained from the book “Simon S. Haykin: Adaptive filter theory. Prentice Hall 1986. ISBN 013004052-5 025. pp. 307-348.” As an alternative to incorporation of an adaptive echo cancellation filter 101, the reproduction of the outgoing audio signal by the loudspeaker 60 can be interrupted during a certain time slice, or the outgoing audio can be reproduced softly, to improve the measurement of the truly external noises.

The noise value summarizer can obtain the noise level value 7, e.g. by averaging the noise power over a number of samples L, followed by a non-linear transformation f:

$$V = f ( {\sum }_{k = 1}^{L} n ( k ) ) \qquad [ 3 ]$$

in which formula V is the noise level value 7.

Since there are different possibilities for obtaining the noise level value 7, the noise level value 7 obtained from the environment is supplied to the processor as an environmental noise level value 21.

In a second noise level value 7 generation possibility, the noise present in the entered audio signal is characterized. This noise also degrades the intelligibility of speech in the outgoing audio signal. For this purpose, a noise value characterizer 13 is included in an embodiment of the audio signal processing apparatus 1. The noise value characterizer 13 can estimate the noise in the entered signal, e.g. by calculating the signal power in frequency bands outside the frequency range for speech. Another possibility is that the noise value characterizer 13 uses the temporal characteristics of the entered audio signal. For example, quieter time slices, in between time slices containing speech, only contain noise. Some of these features for distinguishing noise, voiced speech and other audio signal types are described in literature, e.g. the High Zero-Crossing Rate ratio or the spectrum flux, which can be used in different combinations to reliably differentiate between noise and speech. A number of features are described in “L. Lu, H. Jiang, H. J. Zhang: A robust audio classification and segmentation method. Proc. Int. Conf on Multimedia, 2001, Ottawa (Canada), pp. 203-211.” Most of these features can be used both in the noise value characterizer 13 and in the signal type characterizing means 17, for identifying whether speech is present in the entered audio signal. The noise value characterizer 13 supplies a signal noise level value 23 to the processor.

In a third noise level value 7 generation possibility, a listener enters a noise level value 7 manually, to allow the transformation 2 to optimally improve the intelligibility of speech in the outgoing audio signal, according to the preference of the listener. This can be done e.g. by increasing or decreasing the current noise level value 7, by pushing one or more buttons on a remote control unit 105, which sends a control input signal to a selection input 15, from which a selected noise level value 25 is supplied to the processor 9 by means of a noise value stripper 103, which strips the selected noise level value 25 from the control input signal.

A single noise level value 7 can be generated in a number of ways from the environmental noise level value 21, the signal noise level value 23 and the selected noise level value 25. For example, the noise level value 7 can be set equal to the sum of the environmental noise level value 21 and the signal noise level value 23. Another possibility is that the noise level value 7 is set equal to the selected noise level value 25.

As is further shown in FIG. 2, an embodiment of the audio signal processing apparatus 1 may comprise a signal type characterizing means 17, which supplies a signal type characterization value 18 to the processor 9. Since humans apply the Lombard effect to their speech under noisy conditions, applying the transformation 2 modeling aspects of the Lombard effect to the entered audio signal is mainly interesting when the entered audio signal contains some speech. If the entered audio signal contains only e.g. music or other sounds, e.g. the sound of an animal in a nature documentary, applying a speech intelligibility improving transformation is useless, and the transformation can even deteriorate the quality of the audio signal. Therefore it is interesting to include a signal type characterizing means 17 which can indicate when speech is present in the entered audio signal, and if necessary also how much speech or what type of speech is present. There are a number of alternatives for the signal type characterizing means 17 to obtain the signal type characterization value 18. Often, textual service information is provided by the broadcaster together with the audio. This service information can indicate e.g. whether the audio corresponds to e.g. a jazz song or a news bulletin. Additionally, the signal type characterizing means 17 can use algorithms for analyzing the entered audio signal itself to estimate whether speech is present. For example, speech often has a more pronounced modulation than music, which means that there are relatively silent time slices in between loud, voiced time slices. Another example of speech/music discrimination is described in U.S. Pat. No. 5,878,391. In case there is only music present in the entered audio signal, e.g. a transformation can be applied which sets equalizer settings dependent on the type of music.

FIG. 3 shows an example of a realization of the transformation 2 modeling some of the aspects of the Lombard effect. First, the signal is processed by a pitch modifier 51. Pitch is a psycho-acoustical property which is derived by a human from a sound. There exist technical correlates for pitch, however. Voiced speech production can be modeled as a train of Dirac impulses, representing an excitation by the vocal chords, which is filtered by a filter representing the resonances in the vocal tract, the glottal source spectrum, and the radiation load spectrum. Details can be found e.g. in “R. W. Shafer and L. R. Rabiner: System for automatic formant analysis of voiced speech. Journal of the Acoustical Society of America, vol. 47, no. 2, 1970, pp. 634-648.” and “B. S. Atal and S. L. Hanauer: Speech analysis and synthesis by linear prediction of the speech wave. Journal of the Acoustical Society of America, vol. 50, no. 2, 1971, pp. 637-655.” The pitch of speech is determined by the period of the Dirac impulses. In practice, the first peak in the audio signal spectrum, or the autocorrelation of the audio signal can be used for determining a pitch of an audio signal. With the autocorrelation method, e.g. the pitch T is the time shift which maximizes the correlation:

$$C ( k , T ) = \frac{{i ( k )}^{T} i ( k + T )}{‖ i ( k ) ‖ ‖ i ( k + T ) ‖} , \qquad [ 4 ]$$

where the in-product is typically calculated over a certain number of samples S of the audio signal i(k), and the small T in the exponent of i(k) denotes transposition. Depending on the noise level value 7 V, a new pitch T′ is calculated, e.g. with the following piecewise linear formula:
T′=αᵢVT+βᵢ for Nᵢ≦V<Nᵢ₊₁ [5],
where the constants βᵢ are chosen so that the curve is continuous.

Hence, the more noise is measured, the higher the new pitch T′.

A new signal now has to be synthesized with the new pitch. A number of variants on the Synchronized Overlap and Add (SOLA) technique can be used, e.g. Pitch Synchronous Overlap and Add (PSOLA) or Waveform Similarity based Overlap and Add (WSOLA). These techniques exploit the fact that in an audio signal there are long periodicity time slices, which have a similar excitation waveform a number of times, e.g. 50 times. These excitation waveforms are generated by the vocal tract in response to the Dirac impulse excitations from the vocal chords. A slower phenomenon of change of the vocal tract, e.g. by opening the mouth, is reflected in the audio signal by the fact that after the e.g. 50 similar excitation waveforms, a new excitation waveform is repeated a number of times.

If e.g. it is desired to generate a new audio signal with the same pitch, but a shorter duration, only e.g. 40 of the 50 excitation waveforms are copied to the new audio signal. If a signal is required with the same duration, but a higher pitch, a greater number of excitation waveforms are copied into a time slice of the same duration of the new audio signal, and the excitation waveforms are added where they overlap.

This principle is illustrated schematically in FIG. 6, which shows an old audio signal 301, which is converted to a new audio signal 303 of higher pitch. At a first synthesis time instant 307, a first new waveform 311 of the new audio signal is constructed in the temporal environment of the first synthesis time instant 307. This first new waveform 311 corresponds to a first old waveform 309 of the old audio signal 301. The first analysis time instant 305 at which we perform excision of the first old waveform 309 is determined by the first synthesis time instant 307 and the relationship between the old and the new pitch. The synthesis of the new audio signal 303 can be summarized in the following formula:

$$y ( k ) = \frac{{\sum }_{i} {w}^{2} ( k - iT + {Δ}_{i} ) x ( k - iT + {Δ}_{i} + {τ}^{- 1} ( iT ) )}{{\sum }_{i} {w}^{2} ( k - iT + {Δ}_{i} )} \qquad [ 6 ]$$

In equation [6], the new audio signal 303 y(k) is synthesized at all discrete times k, by overlap, at a discrete number of synthesis time instants, enumerated by i and positioned a temporal distance T apart, of waveforms excised from the old audio signal x. It is further assumed in equation [6] that both the excised and synthesized waveforms are weighted by the same window w. τ⁻¹ (iT) is the analysis time instant corresponding to a synthesis time instant iT, where excision of a waveform from the old audio signal has to occur. However, when adding an excised waveform to a part of the new audio signal already synthesized, one has to be careful that an excised waveform from the old audio signal resembles closely an excitation waveform which is expected to follow the part of the new audio signal already synthesized. Therefore a small offset Δᵢ is introduced, which allows for excision of a waveform at a slightly different discrete time than τ⁻¹ (iT). This is illustrated schematically in FIG. 6 by the fact that at both the third synthesis time instant 323 and the fourth synthesis time instant 327, the same excised third old waveform 325 is added to the part of the new audio signal 303 already synthesized.

More details of various SOLA techniques can be found e.g. in “W. Verhelst, D. Van Compernolle and P. Wambacq: A unified view on synchronized overlap-add methods for prosodic modification of speech. Proceedings of the International Conference on Spoken Language Processing. Beijing October 2002, pp. 63-66.” Another example of audio signal pitch modification is given in U.S. Pat. No. 5,479,564.

Secondly, after pitch modification, the signal is processed by a formant enhancer 53. A formant is a resonance in the vocal tract, which can be modeled by a pole of a vocal tract modeling filter. The formant enhancer 53 achieves its goal e.g. by applying an Autoregressive-moving-average (ARMA) filter to the audio signal leaving the pitch modifier 51, which filter is designed to increase the heights of the formant peaks, while deepening the stretches of the spectrum in between the formants. This increases the steepness of the formants. The ARMA filter coefficients are based upon the noise level value 7. The more noise is measured, the more the formant heights are increased.

Thirdly, a word stretcher 55 increases the duration of words, by decreasing the duration of the silent time slices between words. For example, a constant word stretch can be applied according to the following formula:
w′=Cw when V>N [7],
in which w is the duration of a word, C is a multiplication constant and N is a threshold which V, the noise level value 7, must exceed for word stretching to occur. Hence in the implementation of formula [7], the words are stretched by a predetermined percentage if the measured noise level value 7 is high enough.

Fourthly a signal amplifier 57 boosts the signal power in response to the noise level value, e.g. by means of the following formula:
A=DV [8],
in which A is the amplification factor and D a constant.

After applying these transformations, the outgoing sound is more intelligible.

It is possible that a user of the audio signal processing apparatus 1 activates only some of the described aspects, depending on what he thinks produces the most intelligible speech.

FIG. 4 shows a television receiver 30, which comprises the audio signal processing apparatus 1 for improving the intelligibility of speech present in the audio signal of the received television signal. A television signal enters the television receiver 30 through a television signal input 203. A television baseband audio extraction unit 209 can, if necessary, tune to a desired television channel, demodulate and decompress the television signal, and separates the audio and service information present in the television signal from the video information. The television signal may come from a number of sources, e.g. a satellite dish, a VCR, or Internet. The audio output 5 sends the outgoing audio signal to a first loudspeaker 205 of the television receiver 30 or a loudspeaker externally connected to the television receiver 30. If a second loudspeaker is present, this second loudspeaker can receive the outgoing audio signal from the audio output 5, or from a second audio output, in which case a different transformation 2 may be applied to the entered audio signal to obtain a second outgoing audio signal. The outgoing audio signal can also be sent to an audio signal recorder. The fact that only one audio signal path is shown does not imply that the transformation 2 can only be applied to mono audio signals, but rather the same type of transformation 2 can be applied to a selection of at least some of the channels present in multi-channel audio, e.g. coming from a DVD.

FIG. 5 shows a radio program receiver 40 which comprises the audio signal processing apparatus 1 for improving speech present in the received audio signal. After entering a radio program input 213, a radio baseband audio extraction unit 219 may extract a baseband radio signal from the radio program signal by performing, if necessary, a tuning step, demodulation step, decompression step, etc. The outgoing audio signal is sent to a loudspeaker, e.g. the externally connected loudspeaker 211.

It should be noted that the above-mentioned embodiments illustrate rather than limit the invention and that those skilled in the art are able to design alternatives without departing from the scope of the claims. Apart from combinations of elements of the invention as combined in the claims, other combinations of the elements within the scope of the invention as perceived by those skilled in the art are covered by the invention. Any combination of elements can be realized in a single dedicated element. Any reference sign between parentheses in the claim is not intended to limit the claim. Use of the verb “comprise” and its conjungations does not exclude the presence of elements or aspects not stated in a claim. Use of the article “a” or “an” preceding an element does not exclude the presence of a plurality of such elements. The invention can be implemented by means of hardware or by means of software running on a computer.

1. An audio signal processing apparatus comprising an audio input for obtaining an entered audio signal, an audio output for outputting an outgoing audio signal, and a processor for performing a transformation to improve the intelligibility of speech present in the entered audio signal, characterized in that the processor is arranged to obtain a noise level value indicating the extent of noise influencing the intelligibility of a reproduction of the outgoing audio signal, and has the ability ot transform the entered audio signal into the outgoing signal by the transformation modeling at least one aspect of the Lombard effect, not being audio signal volume control, based upon the noise level value.

2. An audio signal processing apparatus as claimed in claim 1, characterized in that a microphone and a noise value extractor are present for providing the noise level value from environmental noise to the processor.

3. An audio signal processing apparatus as claimed in claim 1, characterized in that a noise value characterizer is present for retrieving the noise level value from the entered audio signal.

4. An audio signal processing apparatus as claimed in claim 1, characterized in that a selection input is present for setting the noise level value to a chosen value.

5. An audio signal processing apparatus as claimed in claim 1, characterized in that a signal type characterizing means is present for supplying a signal type characterization value to the processor, for enabling the processor to perform the transformation of the entered audio signal depending on the signal type characterization value.

6. An audio signal processing apparatus as claimed in claim 1, characterized in that the transformation changes a spectral contour of the entered audio signal, based upon the noise level value.

7. An audio signal processing apparatus as claimed in claim 1, characterized in that the transformation changes a word length of the entered audio signal, based upon the noise level value.

8. A television receiver which is able to improve the intelligibility of speech present in an entered audio signal, characterized in that an audio signal processing apparatus is present, comprising an audio input for obtaining an entered audio signal, an audio output for outputting an outgoing audio signal, and a processor for transforming the entered audio signal into the outgoing audio signal by a transformation modeling at least one change to an audio signal selected from aspects of the Lombard effect, based upon a noise level value available to the processor.

9. A radio program receiver which is able to improve the intelligibility of speech present in an entered audio signal, characterized in that an audio signal processing apparatus is present, comprising an audio input for inputting an entered audio signal, an audio output for outputting an outgoing audio signal, and a processor for tranforming the entered audio signal into the outgoing audio signal by a transformation modeling at least one change to an audio signal selected from aspects of the Lombard effet, based upon a noise level value available to the processor.

10. A method of increasing the intelligibility of speech in an audio signal, the method comprising:
a first step of obtaining an entered audio signal;
a second step of transforming the entered audio signal into an outgoing audio signal; and
a third step of outputting the outgoing audio signal, characterized in that the method obtains a noise level value, indicating the extent of noise influencing the intelligibility of a reproduction of the outgoing audio signal, and transforms the entered audio signal into the outgoing audio signal by a transformation modeling at least one aspect of the Lombard effect, not being audio signal volume control, based upon the noise level value.
